(19) United States
(12) Patent Application Publication
(10) Pub. No.: US 2018/0133621 A1
(43) Pub. Date: May 17, 2018

(54) SYSTEMS AND METHODS FOR INCREASING PRESSURE OF FLUIDS FROM LOW PRESSURE SUBSEA SOURCES USING SUBSEA EDUCTORS

(71) Applicant: Chevron U.S.A. Inc., San Ramon, CA (US)

(72) Inventors: Andrew Mark Titley, Rossmoyne (AU); Devina Aurelia Hardjadinata, Harrisdale (AU); Vijay Rameshchandra Pradhan, Success (AU)

(21) Appl. No.: 15/686,244

(22) Filed: Aug. 25, 2017

(51) Int. Cl. B01D 19/00; E21B 43/36

(52) U.S. Cl. CPC B01D 19/0063; E21B 43/124; B01D 19/0068; E21B 43/36

(57) ABSTRACT

Disclosed are systems and methods for increasing pressure of fluid from a low-pressure (LP) subsea fluid source. Fluid from the LP subsea fluid source is directed to a suction fluid inlet in an eductor at a subsea location. A fluid from a high-pressure (HP) subsea fluid source is directed to a motive fluid inlet in the eductor. An outlet in the eductor discharges a fluid stream having a pressure higher relative to the low-pressure fluid stream. The LP and HP sources can be subsea wells from which oil and gas are produced. The LP and HP sources can be subsea flowline systems through which oil and gas are transported. The LP and HP sources can be fluids to be compressed and compressed fluids, respectively.

### FIELD

The present disclosure relates to methods and systems for increasing pressure of gas and/or liquid from subsea fluid sources such as wells and flowline systems.

### BACKGROUND

As offshore oil and gas reservoirs (also referred to as wells) age or decline, they are depleted because of production over time. In the early life of a producing reservoir, the well fluids are generally flowing from the reservoir pressure to the flowing tubing head pressure (FTHP), also referred to as the flowing wellhead pressure (FWHP), with a significant pressure difference. As the reservoir pressure declines, the pressure difference gradually declines and without the assistance of any type of artificial lift, the well will eventually stop flowing. Depleting low pressure wells, also referred to as “declining wells,” stop producing as the required back pressure at the wellhead becomes equal to or greater than the pressure at the bottomhole of the well. In other words, the lack of driving pressure difference results in low or no flow of well fluids. Consequently, the unproduced reserves remaining in the declining reservoir can only be produced with an enhanced recovery method since at some point the conventional recovery methods become inadequate to produce the remaining reserves.

When not considered in the design of an offshore oil and gas production facility (i.e. subsea application), most of the known enhanced recovery methods are high in capital expense, making further production from such fields economically unattractive. In addition, the use of these equipment requires power and regular maintenance. A common example to boost the fluid recovery from a declining offshore reservoir are the use of semi-submersible pumps or topside booster compressors. While subsea compression is emerging as a new technology, this method is still considered economically unattractive. Another known option for boosting production is the use of eductors located topside where a compressed high-pressure (HP) stream, e.g. a compressor discharge stream, is used as a high-pressure motive fluid to boost the pressure of a low-pressure (LP) fluid, such as the fluid pressure of the declining offshore reservoir. This method is also considered to be economically unattractive in a remote and/or marginal fields application as it requires further capital expense to make the platform available near the wells.

Subsea flowlines and flowline systems can also suffer from lack of driving pressure at various times, such as when producing fluids from a low-pressure reservoir.

A more economically attractive method for enhancing recovery of depleting reservoirs and low-pressure flowline systems would be desirable.

### SUMMARY

In one aspect, a process is provided for enhancing recovery of fluids from a low-pressure source. The process includes passing a first fluid stream from the low-pressure subsea fluid source into an eductor at a subsea location as a suction fluid, and passing a second fluid stream from a high-pressure subsea fluid source into the eductor as a motive fluid. Fluids leaving the eductor are at a higher pressure relative to the first fluid stream.

In another aspect, a system is provided for enhancing recovery of fluids from a low-pressure source. The system includes an eductor at a subsea location receiving well fluids from both the low-pressure subsea fluid source and the high-pressure subsea fluid source. Fluids leaving the eductor are at a higher pressure relative to the low-pressure fluids.

### BRIEF DESCRIPTION OF THE DRAWINGS

These and other objects, features and advantages of the present invention will become better understood with reference to the following description, appended claims and accompanying drawings where:

FIG. 1 is a simplified diagram illustrating an eductor for use in exemplary embodiments.

FIG. 2 is schematic diagrams illustrating subsea configurations for well-to-well pressure boosting in late field life.

FIG. 3 is a schematic diagram illustrating a generic eductor performance curve.

FIG. 4 is a schematic diagram illustrating a subsea production facility including subsea flowlines for producing fluids according to the prior art.

FIGS. 5 and 6 are schematic diagrams illustrating subsea production facility including subsea flowlines for producing fluids in which a higher pressure subsea flowline system boosts the pressure of a lower pressure subsea flowline system in two stages of field production according to exemplary embodiments.

FIG. 7 is a schematic diagram illustrating a subsea production facility including subsea flowlines for producing fluids in which a higher pressure subsea flowline system boosts the pressure of a lower pressure subsea flowline system according to an exemplary embodiment.

FIG. 8 is a graph illustrating flow rate over time according to three exemplary embodiments.

### DETAILED DESCRIPTION

Systems and methods for enhancing recovery of fluids from at least one subsea fluid source by boosting the pressure of the fluids will be described. The systems and methods described herein utilize an eductor for receiving a relatively high pressure fluid, also herein referred to as the high-pressure fluid or HP fluid, and a relatively low-pressure fluid, also herein referred to as the low-pressure fluid or LP fluid, to boost the pressure of the relatively low-pressure fluid.

The term “eductors” refers herein to mechanical devices that combine a high-pressure fluid source, also referred to as a motive fluid, and a low-pressure fluid source, also referred to as a suction fluid, using a nozzle also referred to as a converging-diverging nozzle to produce a discharge stream, also referred to as an outlet flow, having a pressure intermediate the high-pressure and the low-pressure fluid pressures. Eductors operate according to the Venturi effect which is based on Bernoulli's principle that applies the law of conservation of energy to fluid flow. For a given fluid, the velocity of the fluid can be increased with a corresponding reduction of pressure. The Venturi effect can be summarized by the following equation:

Pᵢₙᵢₜᵢₐₗ+½ρv²ᵢₙᵢₜᵢₐₗ+ρghᵢₙᵢₜᵢₐₗ=P_{final}+½ρv²_{final}+ρgh_{final}

where:
P is fluid pressure
ρ is fluid density
v is fluid velocity
g is the acceleration due to gravity
h is hydraulic head

The initial condition refers to the inlet sides of the nozzle; and the final condition refers to the outlet side of the nozzle.

In an eductor, a high-pressure motive fluid enters the inlet side, also referred to as the converging side of the nozzle, at high velocity. As the nozzle converges, the pressure increases and the velocity decreases. At the nozzle outlet, the velocity increases again, creating a low-pressure zone. The low-pressure zone draws or sucks the low-pressure fluid through a second inlet into the mixing duct of the eductor. The high-pressure fluid then transfers its kinetic energy to the low-pressure fluid as they commingle in the mixing duct. The resulting fluid leaving the outlet side of the eductor has a pressure that is between the high-pressure and the low-pressure fluid. This is also referred to as intermediate pressure or medium pressure.

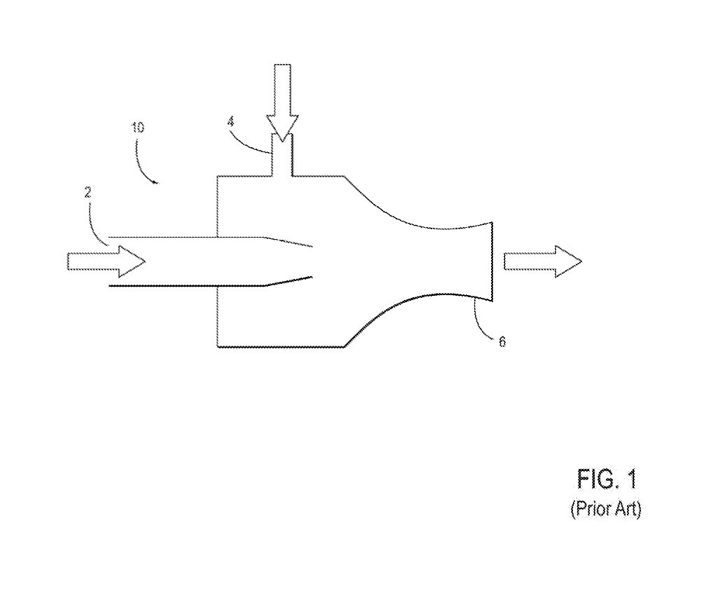

Referring to FIG. 1, a suitable eductor 10 for use in the present systems and methods includes a motive fluid inlet 2 for receiving a high-pressure fluid stream (a motive fluid) from a high-pressure subsea fluid source, a suction fluid inlet 4 for receiving a low-pressure fluid stream (a suction fluid) from a low-pressure subsea fluid source, and an outlet 6 for discharging a fluid stream (a discharge fluid) from the eductor 10 having a pressure higher relative to the low-pressure fluid stream. At least one subsea fluid source at a pressure higher than another subsea fluid source is used as a motive fluid in the eductor to boost the lower pressure fluid. The type of subsea fluid source may vary.

Eductors 10 are commonly designed based on ASME B16.5 which allows for maximum design conditions of 422 barg and 100° C. For some low-pressure fluid sources, fluids can exceed this temperature, in which case a material qualification will be required. In one embodiment, the system utilizes eductor(s) having a nominal diameter of up to 26 inches (66 cm). Increasing the diameter would increase the design and operation complexity as it will eliminate the eductor from the pipeline classification. The equivalent maximum flow through an eductor with a 26 in diameter is approximately 100 to 140 MMscfd, depending on fluid specification and flowing conditions.

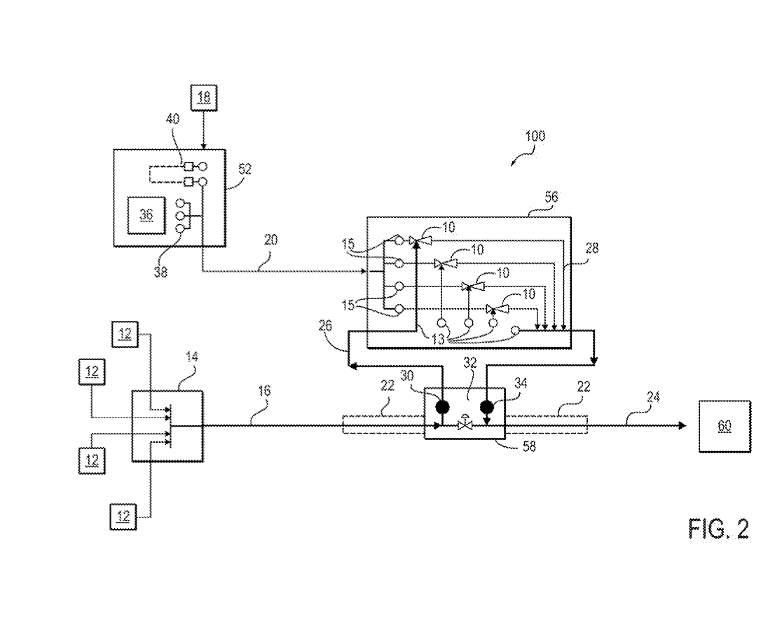

In some embodiments, referring to FIG. 2, the low-pressure subsea fluid source is at least a first subsea well 12 and the high-pressure subsea fluid source is at least a second subsea well 18. Each subsea well 12 or 18 has a bottomhole (not shown) having a flowing bottomhole pressure (FBHP) and a wellhead (not shown) having a flowing wellhead pressure (FWHP). In this embodiment, recovery of fluids from a relatively low pressure subsea oil and/or gas reservoir or well 12, also referred to as the low-pressure reservoir, can be enhanced. Higher pressure fluid from a relatively high pressure subsea reservoir or well 18, also referred to as the high-pressure reservoir, is used to provide the motive fluid in an eductor 10. Both the higher-pressure fluids from the high-pressure reservoir 18 and the lower pressure fluids from the low-pressure reservoir 12 are fed to the inlet side of the eductor 10. The lower pressure fluids from the low-pressure reservoir 12 are fed to the suction fluid inlet 4 of the eductor 10. The higher-pressure fluids from the high-pressure reservoir 18 are fed to the motive fluid inlet 2 of the eductor 10.

In the system 100 shown in FIG. 2, multiple LP wells 12 are connected to a manifold 14 by subsea flowlines. A LP flowline 16 transports production fluids from the manifold 14 to a tie-in skid 58. A flowline 26 is provided to direct low-pressure fluids from the tie-in skid 58 to an eductor skid 56. In the embodiments shown, multiple eductors 10 are mounted on the eductor skid 56. Piping and valves 13 are provided such that the low-pressure fluid in line 26 can be directed to any or all of the eductors 10, i.e., to the suction fluid inlets 4 of the eductors 10. High-pressure fluid from the high-pressure well 18 is directed to an skid 52 before being directed to the eductor skid 56 by a high-pressure flowline 20. High-pressure fluid from flowline 20 can be directed to any or all of the eductors 10 using the valves 15 to control flow.

In one embodiment, a subsea pressure protection system can be applied. Subsea pressure protection systems are designed to shut off flow of high pressure fluid before the design pressure of the subsea system is exceeded. The pressure protection system can be independent of the host and subsea control system, and can use a dedicated controller or logic solver 36 located in a pressure protection control module or skid 52 adjacent to the valves 40, and pressure transmitters 38. The pressure protection control module monitors the transmitters and closes the valves in the event excess pressure is detected. A fixed-logic electronic system can be employed which is not dependent on links to the host. At the skid 52, a logic solver 36 receives pressure information from the HP flowline 20. The HP flowline 20 sends signals to the control valve 40 to close when there is an excessive pressure, thus controlling the HP flow rate going into the eductor 10.

The high-pressure fluid transported by the flowline 20 is directed to the motive fluid inlets 2 of the eductors 10. Line 28 transports discharge fluid from the outlet 6 of the eductors 10. The discharge fluid has a higher pressure than the low-pressure fluid from the LP wells 12, transported by line 16 and line 26. As shown, the fluid flowing in line 28 is directed to line 24, also referred to as the medium pressure flowline or MP flowline 24. MP flowline 24 transports fluid to a host facility 60.

In one embodiment, the eductor 10 can be installed at a relatively late stage of production once production fluid pressure has decreased below a desired level. This production fluid pressure can be monitored using pressure transducers or transmitters, e.g., pressure transducers 38. In one embodiment, the eductor(s) 10 can be by-passed completely to allow normal production or free flow from the LP wells 12 and the HP wells 18 when pressure boosting is not required by opening valve 32. WhenError! Reference source not found. the pressure declines below the desired level (as detected by the pressure transducers), the low-pressure flow is rerouted to the eductor skid 56 where the high-pressure fluid flows boosted the bulk fluid pressure, forming a ‘medium’ pressure flow. The tie-in skid 58 includes valves 30, 32 and 34 thus allowing the low-pressure fluids in flowline 16 to either be directed to the eductor skid 56, i.e., when valve 32 is closed and valves 30 and 34 are open, or allowing the eductor skid 56 to be bypassed, i.e., when valve 32 is open and valves 30 and 34 are closed. In one embodiment, a fortified zone 22 of flowline rated for high-pressure can be provided on either side of the tie-in skid 58. The length of the fortified zone 22 can depend on the production fluid properties, including pressure and GVF, and the speed of actuation of the pressure protection system.

The eductor 10 creates a lower suction pressure which drives production from the low-pressure reservoir 12 to continue even though the reservoir pressure is declining. The higher-pressure fluids from the high-pressure reservoir(s) 18 provide the energy to boost the pressure of the fluids from the low-pressure reservoir(s) 12. The eductor 10 and the motive fluid from the HP well(s) 18 can be used to create the lower suction pressure in the eductor 10, thus reducing the required pressure at the LP well tubing head (the LP FWHP) and allowing more flow and longer period of production before the LP well(s) 18 is overbalanced again. As a result, the fluid leaving the outlet 6 of the eductor 10 has a higher pressure than the lower pressure fluids. In addition to the increased pressure, the additional production from the HP well(s) 18 increases the fluid velocity and overall recovery of the LP fluids from the LP well(s) 12. This can reduce the amount of liquid holdup in LP flowline 16.

The well fluids from the low-pressure reservoir 12 and/or from the high-pressure reservoir 18 can be gaseous hydrocarbons, liquid hydrocarbons or a combination of both gas and liquid. In gas application, the well fluids from the low-pressure reservoir 12 and the well fluids from the high-pressure reservoir 18 are recommended to have a gas volume fraction (GVF) of at least 98.5% (i.e. the ratio of gas volume over the total fluid volume) to maintain the efficiency of the eductor 10. Preferably the well fluids from the low-pressure reservoir 12 are similar in fluid density to the well fluids from the high-pressure reservoir 18 in order to maximize the efficiency of the system.

The low-pressure reservoir 12 can be a mature reservoir in which pressure has declined over time. In another embodiment, the low-pressure reservoir 12 can be a marginal field considered in a newer development. In either case, the methods and systems of the invention can be used to enhance the recovery of well fluids from the low-pressure reservoir 12 using higher pressure reservoir 18.

In one embodiment, the well fluids from the high-pressure reservoir 18 have a pressure at least 50%, even 100%, higher than the pressure of the well fluids from the low-pressure reservoir 12 to achieve the efficiency improvement. The eductor 10 is located at a subsea location, as close as possible to the LP source 12, but this should be assessed such that the HP source 18 is still effective. (i.e. if it's too far from the HP source 18, the differential pressure will have reduced effectiveness). In one embodiment, multiple eductors 10 are provided at the subsea location. Multiple units of eductor may be required depending on the flowrate. The size and quantities of the eductor(s) 10 will depend on the flowrate and technical qualification of the eductor units deployed at the particular site. The combined fluid from high-pressure reservoir 18 and the low-pressure reservoir 12 are divided and directed into each eductor 10 depending on its flowrate capacity. The eductor(s) 10 will be sized to leverage the rate of the HP source 18 as much as possible. Each eductor 10 is capable of receiving well fluids from both the high-pressure reservoir 18 and the low-pressure reservoir 12 such that fluids leaving the eductor are at a higher pressure than the low-pressure reservoir well fluids. The streams from each eductor will recombine and flow to the main flowline 24 at a pressure between the low-pressure and the high-pressure, also referred to as the medium pressure or the intermediate pressure.

The eductor application uses the HP well 18, also referred to as the HP source, as a motive fluid source through a nozzle with a reduced diameter. At the reduced cross sectional area of the nozzle, the velocity of the motive fluid increases. At the nozzle outlet, a low-pressure zone is created which draws in more flow as the suction fluid from the LP wells. As the LP fluid drawn into the low-pressure zone, it commingles with the HP fluid and forms a discharge stream at an intermediate pressure at the eductor outlet. The HP well production rate is exponentially depleting and will start production at the end of the LP production rate plateau. The HP well 18 is considered to have a limited reserve and will stop production once the reservoir pressure declines. To maximize the eductor benefit in the field, the eductor can be applied when the LP wells 12 pressures are declining such that the pressure ratio is maximized.

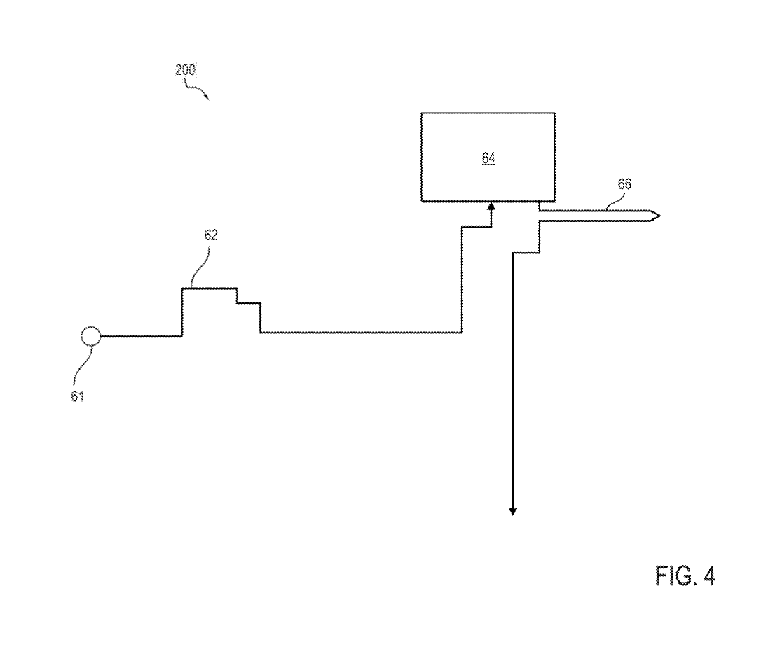

In other embodiments, the low-pressure subsea fluid source is a first subsea system comprising a first flowline for transporting fluid and the high-pressure fluid source is a second subsea system comprising a second flowline for transporting fluid. Referring to FIG. 4, shown is a subsea production facility 200 including subsea flowlines for transmitting production fluids according to the prior art. A first subsea flowline system 62 (also referred to herein as first subsea flowline 62) transmits production fluids from a low-pressure subsea fluid source 61 to a subsea compression unit 64 for pressure boosting by a compressor or pump. Compressed fluids leave the subsea compression unit 64 via flowline 66 at a higher pressure than the pressure of the fluids in the first subsea flowline 62. Flowline 66 can be used to transmit the higher-pressure fluids to any of a number of desired destinations. The path of the flowlines shown are exemplary and arbitrary.

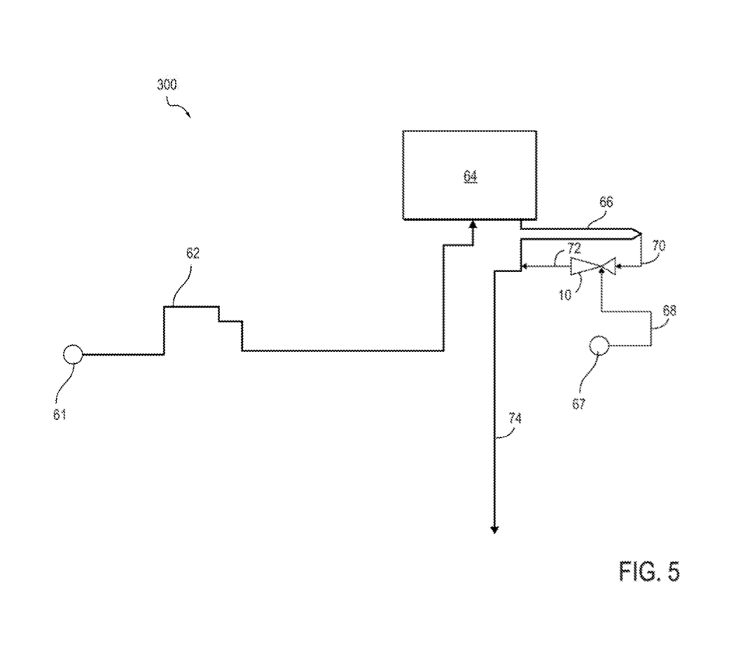

FIG. 5 illustrates system 300 in which an additional low-pressure fluid source 67 is added to the subsea production facility 200. In the embodiment shown, a flowline 68 transports fluids having lower than desirable pressure. An eductor 10 is provided in the subsea facility. Flowline 68 is connected to the suction fluid inlet 4 of the eductor 10. Compressed fluid from line 66 is connected to the motive fluid inlet 2 of the eductor 10 such that the eductor 10 receives a portion or all of the higher-pressure fluids as the motive fluid. As a result of the operation of the eductor 10, a discharge stream having a pressure greater than the suction fluid leaves the outlet 6 of the eductor 10. Discharge fluid from the outlet of the eductor can be connected and returned to the flowline 66 to be combined with compressed fluids from the subsea compression unit 64 (if any were not directed to the eductor) to be transmitted to a desired destination.

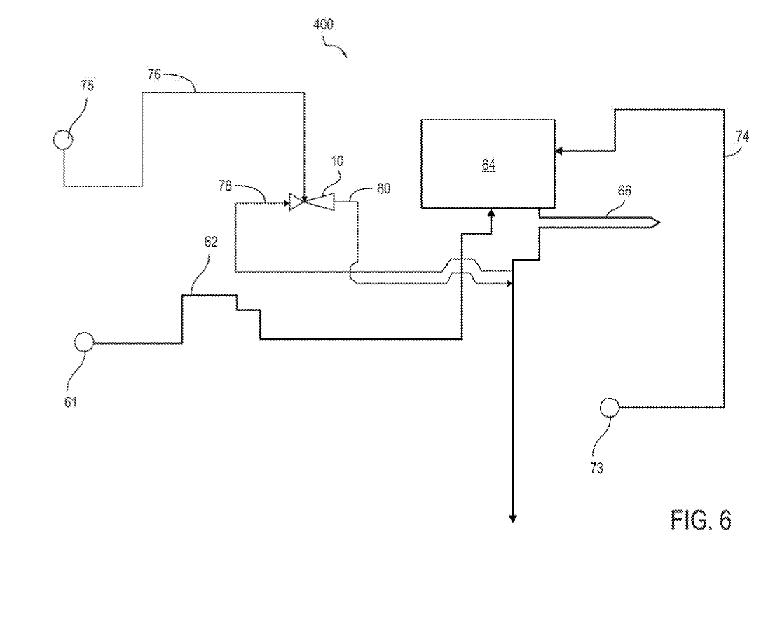

FIG. 6 illustrates another embodiment of the present disclosure in which yet another additional fluid source 75 can be added to the subsea production facility 400 in a similar manner as described above. This scenario can occur over a period of time following the addition of fluid source 75 via flowline 76 as described above. For instance, as a production field matures, rather than adding additional compressor or pumping capacity to the subsea compression unit 64, which is costly, yet another additional fluid source 75 can be brought online by transmitting the lower than desirable fluids to the suction fluid inlet 4 of eductor 10 as the suction fluid. In the scenario illustrated, production fluid from both fluid source 61 and fluid source 73 are directed to the subsea compression unit 64 for pressure boosting by the compressor or pump. The resulting pressure-boosted fluid is directed through flowline 66. A portion or all of the fluid flowing through flowline 66 can be directed to the motive fluid inlet 2 of the eductor 10 in flowline 78 and used as the motive fluid. Again, as a result of the operation of the eductor 10, a discharge stream having a pressure greater than the suction fluid leaves the outlet 6 of the eductor 10 and into flowline 80. Flowline 80 can be connected to the flowline 66 such that the pressure boosted fluids can be returned and combined with the compressed fluids in flowline 66 from the subsea compression unit 64 (if any were not directed to the eductor) to be transmitted to a desired destination.

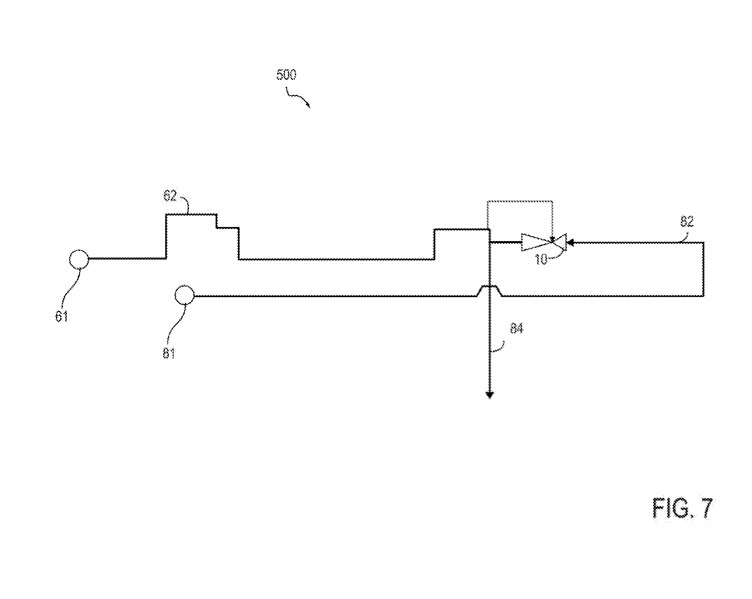

FIG. 7 illustrates another embodiment of the present disclosure in which an eductor 10 is used to boost the pressure of a low-pressure subsea flowline 62 using a high-pressure subsea flowline 82 as the motive fluid source. In this case, the fluids from flowline 62 are the suction fluid, and are directed to the suction fluid inlet 4 of the eductor 10. The high-pressure, motive fluid of flowline 82 from high pressure source 81 is directed to the motive fluid inlet 2 of the eductor 10. As a result, the fluid leaving the outlet 6 of the eductor 10 has a higher pressure than the lower pressure fluids in flowline 62.

In some embodiments, the eductor(s) 10 are located on a dedicated skid or manifold-like structure downstream of the low-pressure fluid source. Such a solution can permit the deferral of capital expenditure in that a production facility can be retrofitted at a time in field life when the low-pressure fluids are in need of boosting.

Advantageously, in some embodiments of the present disclosure, it is not necessary to include mechanical compressors or pumps or other rotating equipment to increase the pressure of the fluids from the low-pressure fluid source. As a result, several components conventionally used in a subsea hydrocarbon production facility to boost production can be eliminated from the system. Such components include mechanical and rotating parts in compressors and pumps, its corresponding power and umbilical requirements and routine maintenance of such components.

As defined herein, the Pressure Ratio (PR) is the ratio of the pressure of the high-pressure fluid to the pressure of the low-pressure fluid. In one embodiment, for a typical gas eductor, the Pressure Ratio can range from 1.5 to 20, and is preferably greater than 2. The Mass Ratio (MR) is defined as the ratio of the mass flow rate of the low-pressure fluid to the mass flow rate of the high-pressure fluid. In one embodiment, the Mass Ratio can be at least 1, e.g. from 1 to 4. For a typical gas application, for example, the gas volume fraction (GVF) can be from 98.5 to 100%. With these conditions, the medium pressure at the eductor outlet 6 would range between 1 to 4 times as high as the pressure of the low-pressure reservoir fluids.

The ratio of the pressure at the outlet 6 of the eductor 10, also referred to as the discharge pressure, to the low-pressure fluid pressure can be estimated based on a generic gas eductor performance curve as shown in FIG. 1. The generic gas eductor performance curve is provided by the manufacturer of the particular eductor. First, the Pressure Ratio (PR) is calculated as the high pressure divided by the low pressure. Seven pressure ratios are shown on the generic performance curve of FIG. 1. The corresponding curve is then selected from the generic gas eductor performance curve. Next, the mass flow ratio (MFR) between the low and high pressure sources is calculated as mass flow rate (i.e., kg/s) of HP divided by mass flow rate of LP. Using the curve, one can determine the Discharge to LP Pressure Ratio at the calculated MFR. Finally, knowing the Discharge to LP Pressure Ratio and the LP Pressure, the Discharge Pressure can be calculated. This Discharge Pressure value can then be used to estimate the actual discharge pressure.

Secondary performance factors such as molecular weight, temperature, the liquid content in the gas phase, and the like, can influence the performance of the eductor. In one embodiment, noise, such as noise above 85 dB, can be suppressed by installing an optional silencer in the eductor. In one embodiment, wear due to erosion where solids are included in the production fluids can be minimized by optionally coating the surface of the eductor with a coating such as stellite or tungsten carbide, or by optionally including a ceramic insert.

### EXAMPLES

Nonlimiting examples were assumed and modeled to demonstrate the advantages of some embodiments. A gas producing field like that shown in FIG. 2 was assumed to have two relatively low pressure wells 12 producing up to 500 MMscfd combined. Over a 15 years' production period, the total recovery of the wells 12 is less than 1.6 tcf. The wells' bottom hole pressure in the early field life is approximately 5.8 psia. The wells 12 are expected to stop producing when they reach a pressure of 940 psia. There is a single high pressure (HP) well 18 nearby with 15% estimated reserve of the other, lower pressure wells 12. The HP well 18 is approximately 700 m deeper than the lower pressure (LP) wells 12 and the reservoir pressure is predicted to be 7,200 psig, about 24% higher than the LP wells. The reservoir properties of each reservoir and well design conditions of the LP wells are as given in Table 1 and Table 2. In the low-pressure wells at early life for this field, the GVF is approximately 99%, thus it will be suitable condition for the eductor. For this study, the fluid is based on the dry composition of an early life fluid, saturated with water at an assumed mid and late life condition.

TABLE 1
Reservoir Properties

| | LP Source | HP Source |
|---|---|---|
| | (two wells) | (one well) |
| Water Depth (m) | 850-900 | — |
| Reservoir Depth (mSS) | 3400-3700 | ~4400 |
| Pressure (psia) | 5230-6240 | ~7200 |
| Temperature (° C.) | 125 | — |
| CGR (bbl/MMscf) | 2-3 | — |
| Formation Water (bbl/MMscf) | 0.7 | — |
| Reserve (%) | 85 | 15 |

TABLE 2
LP Wells Design Conditions

| Parameter | Value |
|---|---|
| FWHP (psia) | 725-4640 |
| FBHP (psia) | 940-5780 |
| ΔP_{FBHP-FWHP} (psi) | 220-1060 |
| FWHT (° C.) | 105 |
| Well Flow rate based on dual completion | 25-150 |
| (MMscfd) | |

To study the benefit of the eductor 10 using modeling, the high-pressure source 18 and the low-pressure source 12 are assumed to be single tanks or reservoirs with no compartments. In this case, as more reserve fluid is flowing out, the pressure in the reservoir depletes. Each year, the annual accumulated recovery is calculated. To meet the maximum capacity of a single eductor unit, the annual recovery is then divided into the number of producing wells with a FWHP which declines at the same rate annually. Following this approach, three sensitivity cases have been considered. As eductor equipment 10 is not part of PIPESIM multiphase flow simulation software available from Schlumberger Limited (Houston, Tex.), the equipment was modeled as a multiphase booster with certain efficiencies. The first case was carried out with an eductor efficiency of 20%, i.e., 20% of a pump. A second case was carried out with a 30% efficiency. A third case, having a 15% efficiency, was based on the generic gas eductor performance curve, as disclosed in Beg, N., et al., Surface Jet Pumps (SJPs) for Enhanced Oil and Gas Production, 1st edition, 2012. These cases present a range of benefit of 46 bcf to 136 bcf of additional recovery reserves from the low-pressure wells 12 over a period from year 26 to year 29.

Based on an eductor diameter of 26 in, i.e., the maximum size without further technical qualification, approximately 140 MMscfd of total flow rate can be achieved. In the three efficiency sensitivity cases considered, this equates to four eductor units used (as shown in FIG. 2).

The result of the simulation suggests that the subsea eductor 10 can increase the production of the LP wells 12 at late field life. The production boost at early field life is restricted by the mass flow rate from the HP well due to the limited HP well flow (i.e., one well 18 boosting multiple wells 12).

Other assumptions made in the PIPESIM multiphase flow simulation include: ambient temperature of the seabed of 15° C.; HP manifolds located 1 km away from the eductor; all lines insulated (UOD=1.1 W/m2K); and fluid density (kg/m3) calculated as MW/23.64, at standard conditions. The mass flow rates are calculated based on the gas volume flow and the density. Assumptions that were used to estimate the FWHP and the production rates include: the FWHP of the LP wells in year 25 is 50 barg; initial FWHP of HP well is 422 barg; and maximum flow is achieved within 1 year.

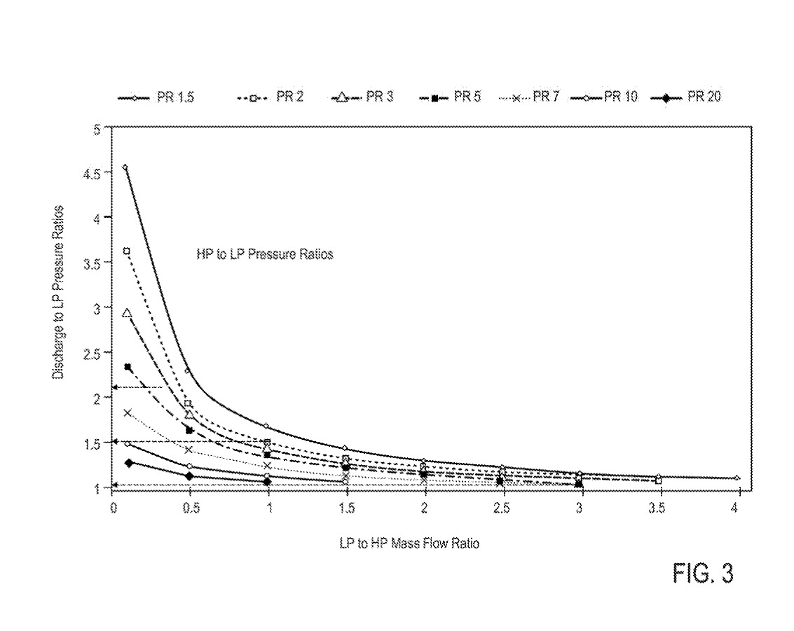

First, the mass ratio was calculated for an eductor at maximum HP flow at year 25 LP wells production. At this condition, the pressure ratio is 8.4 and the mass ratio is 3.1. Referring to the generic gas eductor performance curve (FIG. 3), these operating conditions are very close to the end limit of the operating range. Thus, the eductor application is applied at the subsequent year (year 26) of LP wells production. Rechecking design constraints, both pressure and mass ratio for eductor application at Year 26 of LP wells are within the generic eductor design limit, as presented in Error! Reference source not found..

TABLE 3
Constraint Check

| | Pressure Ratio | |
|---|---|---|
| | Recommended >2 for | Mass Ratio |
| Year | efficiency | 0.1-4 |
| 25 | 8.5 | — |
| 26 | 9.2 | 2.6 |
| 27 | 9.2 | 2.5 |
| 28 | 9.2 | 0.9 |
| 29 | 9.2 | 0.4 |

From the estimated FWHP of the LP wells, the new discharge pressure was calculated for the LP gas rate at the particular year using the curve of FIG. 3. This is repeated for the consequent years until the end of the LP production profile.

The FWHP reduction based on the pressure reduction at the eductor inlet (i.e., the reduction in the suction pressure caused by introducing the HP fluid to the eductor) was then calculated. Without an eductor, the LP wells 12 stop flowing at a particular pressure. In an example, in year 26, the LP wells 12 will not be able to flow more than 300 MMscfd at its FWHP (42 barg). At this condition, the pressure drive between the bottom hole and the tubing head is inadequate such that the well flow is stopped. By introducing the eductor, the FWHP of the LP well can be further reduced to maintain flow from the well, and at the same time providing the required backpressure to maintain flow from the wellhead to the facility. The reduction of the FWHP of the LP well was calculated from the difference between the eductor discharge pressure and the original FWHP. The FWHP of the LP well was also calculated based on the eductor generic performance curve using the same approach.

After the pressure reduction was calculated, the assumption of 3 bcf additional recovery per bar reduction was used to calculate the additional recovery for the particular year. This was then used to determine the new production flow rate for that year, thus determining a new production profile.

Case 1: PIPESIM Multiphase Booster with 20% Efficiency

To obtain the potential benefit of a system utilizing an eductor 10, this scenario in PIPESIM assumes a multiphase booster equipment with 20% efficiency. With the assumption of 3 bcf/bar additional recovery, the pressure reduction of the FWHP of the LP well calculated indicates that the additional recovery is up to 46 bcf from year 26 to year 29 as presented in Error! Reference source not found.

TABLE 1
Case 1 Summary Result

| | | | | | | | Pressure | |
|---|---|---|---|---|---|---|---|---|
| | LP Wells | | HP Well | | | | Reduction | Estimated |
| | Gas Flow | | Gas Flow | | Recovered | Discharge | of FWHP | Additional |
| | rate | FWHP | rate | FWHP | Duty | Pressure | of the LP | Recovery |
| Year | (MMscfd) | (barg) | (MMscfd) | (barg) | (kW) | (barg) | well (bar) | (bcf) |
| 25 | 357 | 50 | 0 | 422 | 0 | — | — | — |
| 26 | 300 | 42 | 115 | 384 | 14505 | 44 | 2 | 7 |
| 27 | 242 | 35 | 96 | 322 | 11923 | 37 | 2 | 5 |
| 28 | 76 | 29 | 81 | 270 | 8132 | 33 | 3 | 10 |
| 29 | 25 | 25 | 68 | 227 | 5243 | 33 | 8 | 24 |

| | |
|---|---|
| TOTAL | 46 |

The recovery from each year was used to estimate the new production rate required for the year. Based on the results, applying the eductor at the LP wells could potentially postponed the end of life for a few years.

Case 2: PIPESIM Multiphase Booster with 30% Efficiency

As the efficiency of the eductor is a conservative assumption, another sensitivity case based on 30% efficiency was carried out. This assumption increases the additional recovery to 100 bcf, approximately 54% more than in Case 1. The recovered duty from the HP wells and the pressure reductions in FWHP of the LP well are presented in Error! Reference source not found.

TABLE 2
Case 2 Summary Result

| | | | | | | | Pressure | |
|---|---|---|---|---|---|---|---|---|
| | LP Wells | | HP Well | | | | Reduction | Estimated |
| | Gas Flow | | Gas Flow | | Recovered | Discharge | of FWHP | Additional |
| | rate | FWHP | rate | FWHP | Duty | Pressure | of the LP | Recovery |
| Year | (MMscfd) | (barg) | (MMscfd) | (barg) | (kW) | (barg) | well (bar) | (bcf) |
| 25 | 357 | 50 | 0 | 422 | 0 | — | — | — |
| 26 | 300 | 42 | 115 | 384 | 14527 | 44 | 5 | 14 |
| 27 | 242 | 35 | 96 | 322 | 11929 | 36 | 4 | 12 |
| 28 | 76 | 29 | 81 | 270 | 9568 | 32 | 8 | 24 |
| 29 | 25 | 25 | 68 | 227 | 7170 | 30 | 17 | 50 |

| | |
|---|---|
| TOTAL | 100 |

Case 3: Generic Performance Curve

Another sensitivity case for this scenario was carried out using the generic performance curve. The previously calculated mass and pressure ratio are used to obtain the expected ratio of discharge to LP pressure.

From the values obtained from the y-axis (i.e. discharge to LP pressure ratio), the estimated discharge pressure for each year with the subsea eductor can be determined. Error! Reference source not found. presents the pressure reduction of the FWHP of the LP well based on the eductor performance curve (FIG. 3), and its estimated additional recovery.

TABLE 3
Case 3 Summary result

| | | | | | Pressure | |
|---|---|---|---|---|---|---|
| | Pressure | Mass | | | Reduction | Estimated |
| | Ratio | Ratio | | | of FWHP | Additional |
| | (P_{HP}/P_{LP}) | (m_{LP}/m_{HP}) | | P_{D} | of the LP | Recovery |
| Year | 2-75 | 0.1-4 | P_{D}/P_{LP} | (barg) | well (bar) | (bcf) |
| 25 | 8.5 | — | — | — | — | — |
| 26 | 9.2 | 2.6 | 1.1 | 44 | 2 | 7 |
| 27 | 9.2 | 2.5 | 1.1 | 37 | 2 | 6 |
| 28 | 9.2 | 0.9 | 1.5 | 43 | 14 | 41 |
| 29 | 9.2 | 0.4 | 2.1 | 52 | 27 | 82 |

| | |
|---|---|
| TOTAL | 136 |

Following similar method to previous case, the new flow rates based on the additional recovery were calculated. Compare to the previous two cases, the estimated additional recover can be up to 136 bcf or 7% of the original LP wells recovery. With a maximum flow rate of 115 MMscfd, the HP wells could potentially contribute an additional 119 bcf for the eductor application from year 25 to year 29 of LP wells production. This additional recovery is almost 3 times and 1.5 times more than the previous two cases with PIPESIM multiphase booster of 20% and 30% efficiency respectively. This suggests that the multiphase booster in PIPESIM gives much more conservative approach to model the eductor performance without any tuning. Based on 20% and 30% multiphase booster efficiency in PIPESIM, the estimated additional recovery could be 46 bcf and 100 bcf respectively. This contributes to 3-4% of the original LP wells recovery.

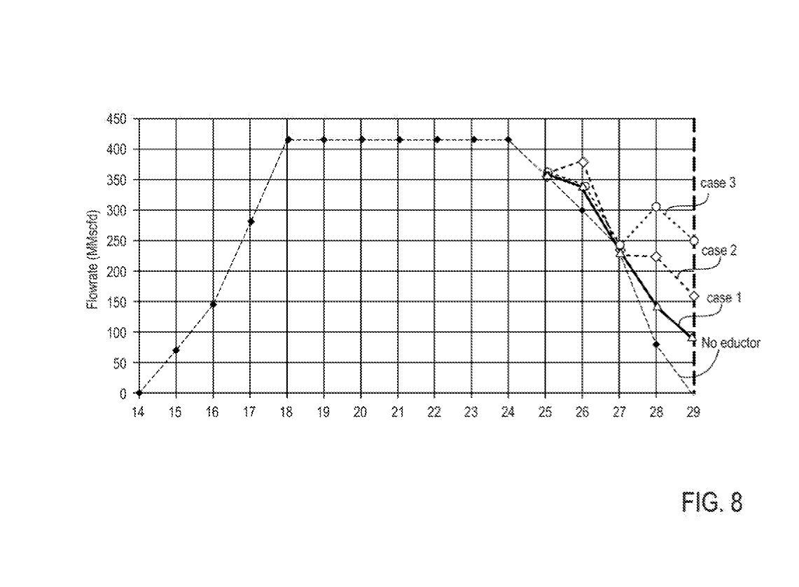

To illustrate a comparison of the sensitivity cases, flowrate of all examples, i.e., flowrate of production from the two low-pressure wells 12 without the use of an eductor and from the two low-pressure wells 12 with the use of an eductor at the three efficiency levels, are presented in Table 7 and FIG. 8Error! Reference source not found. At year 27, the combination of LP FWHP and flow rate requires slightly higher HP gas flow rate. This is reflected in FIG. 8 Error! Reference source not found. where the flow rate estimations are slightly reduced.

Table 7 summarizes yearly performance for production years 25-29 for the single high-pressure well and multiple low-pressure wells employing the eductor units without the use of additional compression. Table 7 compares the estimated annual gas rate from the system based on the three different eductor efficiency assumptions. As can be seen, the use of eductors results in significant pressure boosting when a higher pressure, motive fluid is used, i.e., when the HP Well Flow Rate is not zero (0). As can be seen from FIG. 8, the use of the eductors at all three efficiency levels results in improved flowrate as compared with the comparison example without the use of an eductor.

TABLE 7
Summary of Flow rates, Produced Reserve and Number of Eductors

| | | | LP Wells (with Eductor) | | | | | |
|---|---|---|---|---|---|---|---|---|
| | | | Multiphase | | Multiphase | | Generic | |
| | | LP Wells | Booster | | Booster | | Performance | |
| | HP Well | (without | 20% Efficiency | | 30% Efficiency | | Curve | |
| | Flow | Eductor) | HP + LP | | HP + LP | | HP + LP | |
| | rate | Flow rate | Flow rates | No. of | Flow rates | No. of | Flow rates | No. of |
| Year | (MMscfd) | (MMscfd) | (MMscfd) | Eductors | (MMscfd) | Eductors | (MMscfd) | Eductors |
| 25 | 0 | 357 | 357 | — | 357 | — | 357 | — |
| 26 | 115 | 300 | 453 | 4 | 493 | 4 | 451 | 4 |
| 27 | 96 | 242 | 327 | 3 | 322 | 3 | 335 | 3 |
| 28 | 81 | 76 | 223 | 2 | 303 | 3 | 386 | 3 |
| 29 | 68 | 0 | 160 | 2 | 224 | 2 | 313 | 3 |

Further benefits of the systems and methods disclosed include having no rotating equipment in a subsea environment, thus very little maintenance is needed. The systems can be more quickly deployed for subsea installation compared to other subsea equipment, e.g. compressors. The systems can also be customizable to make them erosive and corrosive resistant.

It should be noted that only the components relevant to the disclosure are shown in the figures, and that many other components normally part of an oil production facility system are not shown for simplicity.

Unless otherwise specified, the recitation of a genus of elements, materials or other components, from which an individual component or mixture of components can be selected, is intended to include all possible sub-generic combinations of the listed components and mixtures thereof. Also, “comprise,” “include” and its variants, are intended to be non-limiting, such that recitation of items in a list is not to the exclusion of other like items that may also be useful in the materials, compositions, methods and systems of this invention.

From the above description, those skilled in the art will perceive improvements, changes and modifications, which are intended to be covered by the appended claims.

What is claimed is:

1. A process for increasing pressure of fluids from a low-pressure subsea fluid source, comprising:
passing a first fluid stream from the low-pressure subsea fluid source into an eductor at a subsea location as a suction fluid; and
passing a second fluid stream from the high-pressure subsea fluid source into the eductor as a motive fluid wherein the second fluid stream is at a higher pressure relative to the first fluid stream such that a discharge fluid stream emerges from the eductor having a pressure higher relative to the first fluid stream.

2. The process of claim 1, wherein the low-pressure subsea fluid source is a first subsea system comprising a flowline for transporting fluid and the high-pressure fluid source is a second subsea system comprising a flowline for transporting fluid.

3. The process of claim 1, wherein the low-pressure subsea fluid source is a first subsea well and the high-pressure subsea fluid source is a second subsea well.

4. The process of claim 1, wherein the second fluid stream has a pressure at least 50% higher than the first fluid stream.

5. The process of claim 1, wherein the second fluid stream has a pressure at least 100% higher than the first fluid stream.

6. The process of claim 1, wherein the first fluid stream and the second fluid stream comprise fluids selected from the group consisting of gaseous hydrocarbons, liquid hydrocarbons and combinations thereof.

7. The process of claim 1, wherein the first fluid stream and the second fluid stream comprise gaseous hydrocarbon streams each having a gas volume fraction greater than 98.5%.

8. The process of claim 1, wherein the first fluid stream and the second fluid stream comprise liquid hydrocarbons.

9. A process for increasing pressure of fluids from a subsea fluid source, comprising:
a. monitoring pressure of a first fluid stream from a first subsea fluid source with a pressure sensor; and
b. upon detection of a predetermined low pressure signal by the pressure sensor indicating low pressure in the first fluid stream:
i. passing a second fluid stream from a high-pressure subsea fluid source into an eductor at a subsea location as a motive fluid; and
ii. passing the first fluid stream from the first subsea fluid source into the eductor as a suction fluid wherein the first fluid stream is at a lower pressure relative to the second fluid stream such that a discharge fluid stream emerges from the eductor having a pressure higher relative to the first fluid stream.

10. A system for increasing pressure of fluids from a low-pressure subsea fluid source, comprising:
a. an eductor at a subsea location comprising:
i. a motive fluid inlet for receiving a high-pressure fluid stream from a high-pressure subsea fluid source;
ii. a suction fluid inlet for receiving a low-pressure fluid stream from a low-pressure subsea fluid source; and
iii. an outlet for discharging a fluid stream from the eductor having a pressure higher relative to the low-pressure fluid stream.

11. The system of claim 10, wherein the low-pressure subsea fluid source is a first subsea system comprising a first flowline for transporting fluid and the high-pressure fluid source is a second subsea system comprising a second flowline for transporting fluid;
further comprising piping connecting the first flowline with the suction fluid inlet and the second flowline with the motive fluid inlet.

12. The system of claim 10, wherein the low-pressure subsea fluid source is a first subsea well and the high-pressure subsea fluid source is a second subsea well, further comprising piping connecting the first subsea well with the suction fluid inlet and the second subsea well with the motive fluid inlet.

13. The system of claim 10, wherein the low-pressure fluid stream and the high-pressure fluid stream comprise fluids selected from the group consisting of gaseous hydrocarbons, liquid hydrocarbons and combinations thereof.

14. The system of claim 10, wherein the low-pressure fluid stream and the high-pressure fluid stream comprise liquid hydrocarbons.

15. The system of claim 10, further comprising:
a. a pressure sensor for monitoring a pressure of the low-pressure fluid stream; and
b. a control system for receiving pressure signals by the pressure sensor;
wherein upon detection of a predetermined low pressure signal by the pressure sensor indicating low pressure in the low-pressure fluid stream, the control system:
i. redirects flow of the low-pressure fluid stream into the eductor as the suction fluid; and
ii. directs the high-pressure fluid stream from the high-pressure subsea fluid source into the eductor as the motive fluid;
such that a discharge fluid stream emerges from the eductor having a pressure higher relative to the low-pressure fluid stream.

16. The system of claim 10, wherein the system comprises a plurality of eductors at the subsea location.

17. The system of claim 10, wherein the system does not include a mechanical compressor or pump to increase the pressure of the low-pressure fluid stream such that the fluid stream from the eductor having a pressure higher relative to the low-pressure fluid stream does not pass through a mechanical compressor or pump.
